(19) United States
(12) Patent Application Publication
(10) Pub. No.: US 2016/0305487 A1
(43) Pub. Date: Oct. 20, 2016

(54) COUPLING

(71) Applicant: PUNK COUPLINGS LIMITED, Bristol (GB)

(72) Inventor: Simon PARKER, Bristol (GB)

(21) Appl. No.: 15/177,631

(22) Filed: Jun. 9, 2016

Related U.S. Application Data
(63) Continuation-in-part of application No. PCT/GB2014/053680, filed on Dec. 12, 2014.

(30) Foreign Application Priority Data
Dec. 13, 2013 (GB) 1322097.5
Jun. 11, 2015 (GB) 1510136.3
Jun. 11, 2015 (GB) 1510137.1
Oct. 22, 2015 (GB) 1518768.5

(51) Int. Cl. F16D 3/205; F16D 3/44; F16D 41/12; F16D 3/42

(52) U.S. Cl. CPC F16D 3/2052; F16D 3/42; F16D 3/44; F16D 41/12

(57) ABSTRACT

A coupling comprises a pair of members: a first member having an outer convex spherical periphery centred about a central point and a torsional axis extending through the central point, and a second annular member has an inner concave spherical periphery centred on the central point and complementary to the outer periphery of the inner first member. The spherical surfaces of the inner and outer members co-act to transmit radial loads and loads acting along the common. Axles extend radially of the central point and couples the first and second annular for transmitting torsional load from one to the other. The each of the pair of members is rotatable one relative to the other about the said central point in a direction constrained by the axle arrangement.

This application is a Continuation-in-Part of:

International Application No. PCT/GB2014/053680 filed in English on 12 Dec. 2014 claiming priority to GB Application No GB1322097.5 filed 13 Dec. 2013;

GB Application No. GB1510136.3 filed 11 Jun. 2015 in English; GB Application No. GB1510137.1 filed 11 Jun. 2015 in English; and

GB Application No. GB1518768.5 dated 22 Oct. 2015.

The entire contents of these applications are incorporated herein by reference.

### TECHNICAL FIELD AND BACKGROUND

The present invention relates to a coupling.

Mechanical couplings are well known. Examples include couplings for coupling angularly misaligned shafts, universal joints, constant velocity joints, couplings for coupling a drive shaft to a driven shaft; couplings for connecting a torque shaft to a structural element of for example a suspension system.

### SUMMARY OF INVENTION

According to the present invention a coupling has an inner member and an outer annular member and comprises
one or more pairs of members, which may or may not include one or both the inner and outer members, each pair being a first member and a second annular member with a common axis and having a common first centre on the axis;
the first member having an outer convex spherical periphery;
the second annular member having an inner spherical concave periphery in which the outer convex periphery of the first annular member is received;
the outer convex periphery and the inner concave peripheries being concentric about the first centre and complementary to one another and co-acting with one another to transmit axial loads acting along the torsional axis between them;
one or a diametrically opposed pair of axles disposed radially of the common centre of the pair of members coupling the first and second members for transmitting torsional load from one of the members to the other; the first and second annular members being constrained by the axle(s) to be rotatable one relative to the other about the axle(s).

For most practical applications the said members, other than the outer member, comprise spherical segments including a common centre. A spherical segment is a portion of a sphere between with a pair of parallel planes. However, it is possible to consider, in some circumstances, situations in which a segment of a sphere is used in which the planes are not parallel but non-intersecting or which is cut by cones whose apexes are on the common axis—such alternatives would have disadvantages both in manufacture, assembly and use and seem less likely to be adopted.

The inner member and the outer annular member may comprise a pair of members coupled by the at least one axle, or there may be one or more intermediate members disposed between the inner and outer members, each pair of adjacent members comprising a pair of members coupled together by axles.

The axle(s) carries torque and the spherical surfaces of the first and second members carry axial and radial loads. Most of any axial load is carried by the spherical surfaces. The axle(s) may also carry some of the axial load. Thus radial and axial loads are separated from torsional loads. In an embodiment, the axle(s) are configured to not transmit radial loads between the members coupled thereby so that radial loads are not carried by the axles. Thus radial loads are carried mostly or wholly by the spherical surfaces.

Other features of the invention are set out in the claims and, without limitation in the examples below.

Couplings according to various embodiments the present invention described may be used for coupling any two structural elements that must be coupled with at least one rotational degree of freedom. Some examples are useful as ‘structural static couplings’ coupling an element to a fixed structure. Other examples are useful as rotational ‘flexible couplings’ coupling two rotational elements. Couplings according to the invention, for example, may be used to couple angularly misaligned shafts, or as universal joints, constant velocity joints, couplings for coupling a drive shaft to a driven shaft, and as couplings for connecting steered hub to a fixed structural element such as a suspension arm in a suspension system.

### DESCRIPTION OF DRAWINGS

Some examples of the invention are described below with reference to the accompanying drawings, in which:

FIG. 1 illustrates a reference frame of operation of couplings according to embodiments of the invention;

FIGS. 2A to 2C show an example of a coupling according to the invention, of which FIG. 2A is an axial view with the elements of the coupling un-aligned, FIG. 2B is a cross-sectional view of FIG. 2A along axis A3 and FIG. 2C is a cross-sectional view of FIG. 2A along axis A2;

FIGS. 3A and 3B show a hub centre steering mechanism including an example of a coupling according to FIG. 2, of which FIG. 3A is an isometric view and FIG. 3B is a cross-sectional view;

FIGS. 4A to 4F show another example of a coupling according to the invention, of which FIG. 4A is an axial view along axis A1 of FIG. 1, FIG. 4B is a cross-sectional view along plane A-A in FIG. 4A, FIG. 4C is a cross-sectional view along plane B-B in FIG. 4A, FIG. 4D is an axial view showing the elements of the coupling un-aligned, FIG. 4E is an axial cross-sectional view of the coupling of in FIG. 4A and FIG. 4F is a cross sectional view along plane A-A of FIG. 4D;

FIGS. 5A and 5B are cross-sectional views of a pair of the couplings of FIG. 4 connected together;

FIGS. 6A to 6F show a further example of a coupling according to the invention, of which FIG. 6A is an axial view along axis A1 of FIG. 1, FIG. 6B is a cross-sectional view along plane A-A in FIG. 6A, and FIG. 6C is a cross-sectional view on plane B-B of FIG. 6A, FIG. 6D is a side view; FIG. 6E is a cross-sectional view along plane C-C of FIG. 6D; and FIG. 6F is a side cross-sectional view of the coupling along plane D-D of FIG. 6D;

FIGS. 7A, 7B and 7C show bearings on one representative member of a coupling according to the invention, in which FIG. 7A is an isometric view of the coupling, and FIG. 7B is a cross sectional axial view, and FIG. 7C is an exploded view;

FIG. 8 shows means for limiting relative rotation of elements of a coupling according to the invention;

FIG. 9 is a cross-sectional view of a modification which may be applied to couplings in accordance with the invention;

FIG. 10 is across-sectional view of a representative coupling in accordance with the invention within a bearing;

FIGS. 11A and 11B illustrate a way of assembling the coupling described in the previous examples;

FIGS. 12 to 14 show a wet coupling according to the invention with and end cover;

FIG. 12 is a section though a coupling similar to that illustrated in FIG. 4 but having a flange to join the outer member to another item;

FIG. 13 is an isometric drawing of the intermediate member 402 of FIG. 12;

FIG. 14 shows an exploded view of the coupling of FIG. 12;

FIG. 15 is an end on view of an alternative embodiment to that shown in FIGS. 12 to 14 looking in the direction of of FIG. 16;

FIG. 16 is a side view of the alternative embodiment;

FIG. 17 is a vertical section of the embodiment in the line A-A of FIG. 15;

FIG. 18 is a perspective view of the embodiment;

FIG. 19 is a section in figure B-B of FIG. 15;

FIG. 20 shows an end on view of a Spragg clutch utilising the coupling of the present invention and also showing end caps and lubrication ducts;

FIG. 21 shows a vertical section through the coupling of FIG. 21, the section being through the axis of the coupling;

FIG. 22 shows a section orthogonal to that in FIG. 22 though the axis of the coupling;

FIG. 23 is a section of the clutch of FIG. 21 on a plane containing the spring wire in FIGS. 22 and 23;

FIG. 24 shows an exploded view of the components of the coupling and Spragg clutch of FIGS. 21 to 24, and

FIG. 25A to 25F show an example of the invention with an alternative loading slot arrangement;

FIG. 26A shows an axial view of the coupling of FIGS. 25A to 25F, FIG. 26B shows a vertical section through of the coupling of FIG. 26A; and

FIG. 27 shows an exploded view of the coupling of FIGS. 25 and 26.

### DESCRIPTION OF EXAMPLES OF THE INVENTION SHOWN IN THE DRAWINGS

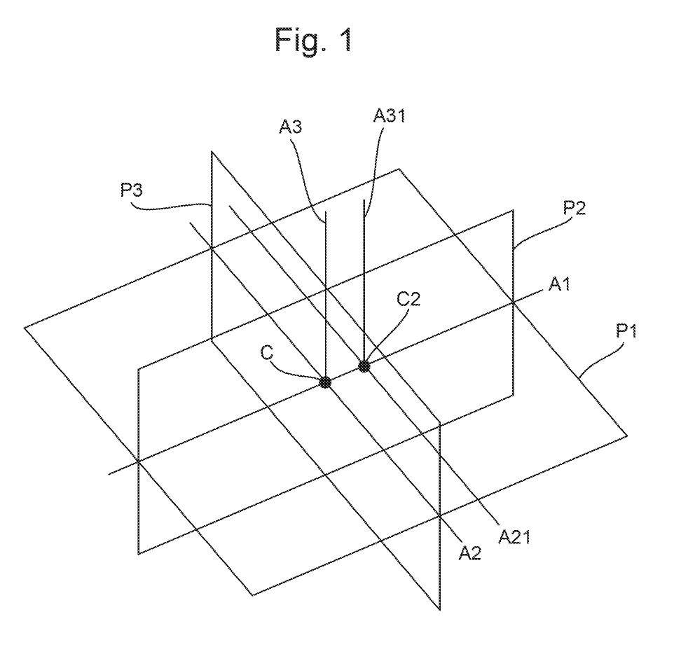

The examples of the invention in the drawings are described in relation to a reference frame as shown in FIG. 1.

The reference frame has a first axis A1 defining an axial direction. A second axis A2 is perpendicular to the first axis A1. At the intersection of the first and second axes is a central point C of concentric spherical surfaces of concentric members of the couplings. The first and second axis and the central point lie in first plane P1 and the first axis and central point lie in a second plane P2 perpendicular to the first plane. A third plane P3 through the centre point C is perpendicular to the other planes. A third axis A3 defines is perpendicular to axes A1 and A2, lies in the third plane and passes through the central point C.

The first axis A1 is a torsional axis on which, for example, a drive shaft or driven shaft is connected to the coupling and the second A2 and third A3 axes are axes of relative rotation of members of the couplings.

In further examples, couplings have some members centred on the central point C and other members centred on a further central point C2 offset from C along the first axis A1 when the members are aligned. The offset of C2 from C may be slight, for example a fraction of a millimetre. Further axes A21 and A31, parallel to axes A2 and A3 respectively pass through the central point C2.

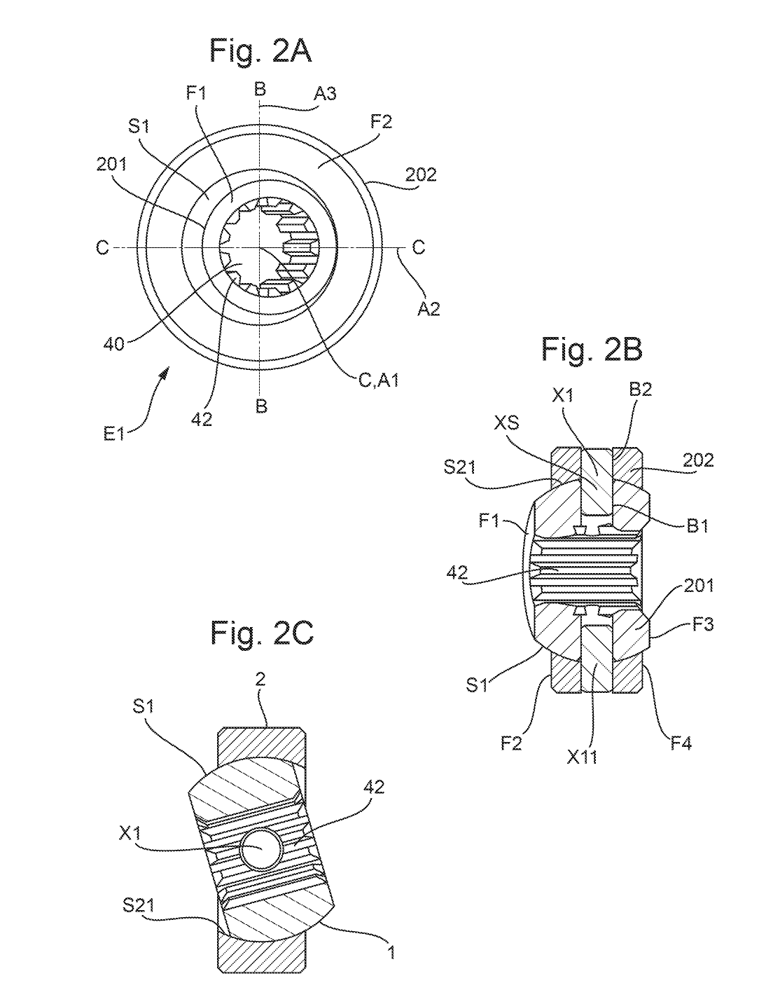

In FIG. 2, a coupling comprises an inner annular member 201 around the first axis A1. The inner member 201 comprises a spherical segment about central point C and has an outer peripheral surface S1 which is convexly spherical centred on the central point C on the first axis. The inner member 201 has a central cylindrical bore 40 which in this example has splines 42 for engaging a correspondingly splined shaft.

An outer annular member 202 has an inner peripheral surface S21 which is convexly spherical complementary to the outer surface S1 of the inner member 201. The concave spherical surface S21 is centred on the same central point C on the axis as the spherical surface of the inner ring. In this example the inner spherical surface S21 of the outer ring and the outer spherical surface S1 of the inner member 201 are contiguous plain bearing surfaces.

The inner and outer annular members 201, 202 are coupled by an axle arrangement comprising a diametrically opposed pair of axles X1 and X11 which are on a common axis through the central point C, in this case on axis A3. The pair of axles constrains the inner and outer rings to be rotatable, one relative to the other, about axis A3.

Each of the axles X1 and X11 comprises an axle shaft XS fixed in a bore B2 in the outer annular member 202 and extending into a bore B1 in the inner member 201 in which it is free to rotate. The shafts are arranged so that they do not transmit radial loads between the inner and outer rings. That is done by providing radial clearance between the ends of the axles and the radially adjacent spherical surfaces and by allowing some radial freedom of movement in the bore B1 between the shaft XS and the inner member 201: these arrangements isolate the axles from both radial and axial loads.

The shafts may be fixed in the outer annular member 202 by an interference fit or be otherwise fixed by for example a cold weld.

The axles may take other forms. The shaft XS may have a head in a recess in the outer surface of the outer member 202 so as to not protrude above the outer surface and be fixed in the outer member 202 by a screw-threaded engagement in the bore B2 in the outer member.

The axles retain the inner member 201 axially within the outer member 202. In addition, the spherical surfaces of the inner and outer members coact to retain the inner member axially within the outer member.

The central point C of the adjacent convex and concave spherical surfaces lies between the axial facing faces F1 and F3 of the inner member 201 and between the faces F2 and F4 of the outer member 202. As a result of that, the periphery of the inner convex spherical surface mid-way between the axially facing faces F1 and F3 is at a greater radius than the periphery of the concave surface of the outer member 202 at the axially facing faces thereof F2 and F4. Thus the inner member 201 is retained axially in the outer annular outer member 202 over an operational range of rotation of the inner annular member 201 about the second axis and/or about the first axis.

In the example in FIG. 2, the inner member 201 has splines in its central cylindrical bore for engaging a shaft. Splines (not shown) may additionally or alternatively be provided on the outer periphery of the outermost member (in this case outer annular member 202) for engaging another shaft. The coupling may be allowed to slide relative to the shaft(s) providing an axial degree of freedom.

The first and second annular members are each a section of a sphere centred on the central point C at the intersection of the first A1 and second A2 axes.

In FIG. 2 as shown there are two diametrically opposite axles X1 and X11 which share loads on the coupling. One could be omitted if a coupling is being designed to operate under light loads.

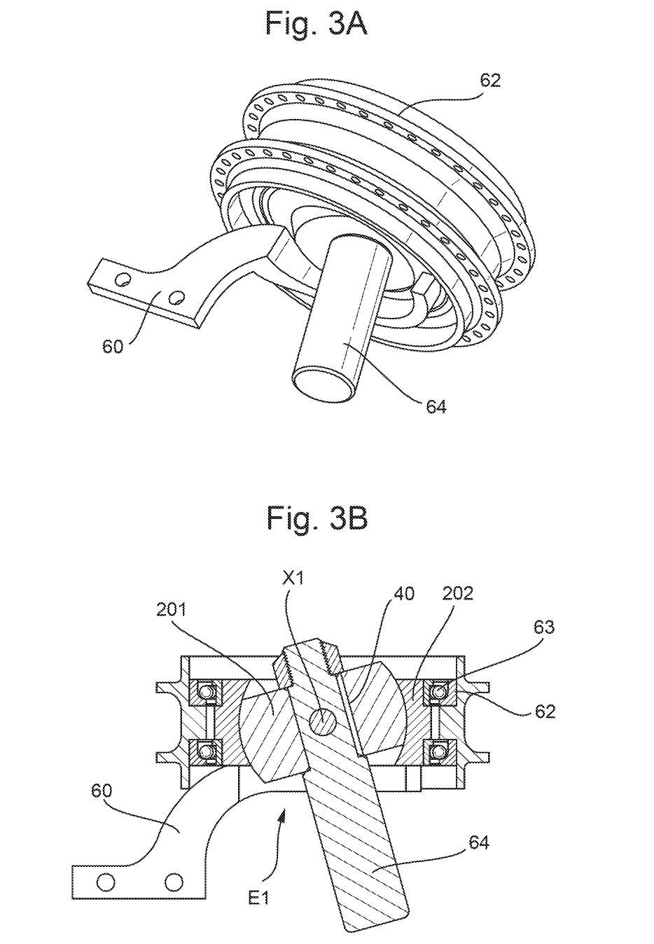

The example of FIG. 2 has static applications such as Hub Centre Steering as shown in FIG. 3.

In FIG. 3 a steered wheel hub 62 of a wheel is supported by a support member 64 which in this example is a suspension arm. The coupling E1, as described with reference to FIG. 2 couples the suspension arm 64 to the steered wheel hub 62. The arm 64 is engaged, for example by splines, in the central bore 40 of the inner ring 201 of the coupling E1. The axles(s) X1, X11 (only X1 shown) allow the outer annular member 202 to rotate about one axis (the steering axis) relative to the inner annular member 201 and arm 64. The outer annular member 202 supports the wheel 62 which is free to rotate on bearings 63. A steering arm 60 is fixed to the outer annular member 202 to rotate it relative to the inner ring and arm 64.

In this example the axle(s) X1, X11 provide support to allow relative rotation but do not drive the wheel hub 62.

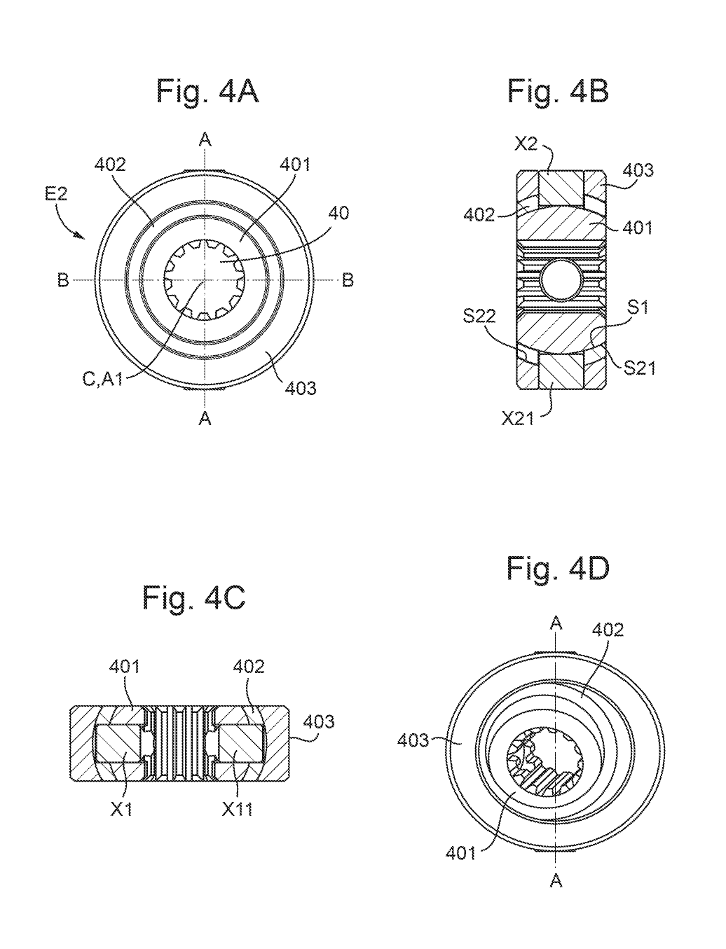

A further example of a coupling is shown in FIG. 4 comprising an inner annular member 401 centred on a first axis, the inner annular member 401 having an outer peripheral surface S1 which is convexly spherical centred on the point C on the axis A1. The inner annular member 401 has a central cylindrical bore 40 has splines for engaging a correspondingly splined shaft.

An intermediate annular member 402 has an inner peripheral surface S21 which is concavely spherical complementary to the outer surface S1 of the inner member 402. In this example the inner spherical surface S21 of the second member and the outer spherical surface S1 of the inner member 401 are contiguous plain bearing surfaces.

A first pair of diametrically opposed axles X1 and X11 extend radially of, the first axis A1 on the third axis A3 to couple the inner member 401 to the intermediate member 402. The first and second axles constrain the inner and intermediate members to rotate one relative to the other about the third axis A3. The intermediate member 402 has an outer periphery S22 which is convexly spherical. An outer annular member 403 has an inner peripheral surface S31 which is concavely spherical complementary to the outer surface S22 of the intermediate member 402. In this example the inner spherical surface S31 of the outer member 403 and the outer spherical surface S22 of the intermediate member 402 are contiguous plain bearing surfaces.

A second pair of diametrically opposed axles X2 and X21 extend radially of, the first axis A1 along the second axis A2 perpendicular to the third axis A3 to couple the intermediate member 402 to the outer member 403. The axles X2 and X21 constrain the intermediate 402 and outer 403 members to be rotatable one relative to the other about the second axis A2 of rotation (see FIG. 1) through the centre point C, and perpendicular to the first axis A1 and perpendicular to the third axis A3. The second pair of axles allows relative rotation of the pair of members comprising intermediate and outer members 402 and 403 independently of the pair of members comprising inner and intermediate members 401 and 402.

In similar manner as described with reference to FIG. 2, the spherical surfaces S1, S21, S22 and S31 bear loads acting radially of the axis A1 and in the direction of the axis A1. The axles transmit torque between the inner 401, intermediate 402, and outer 403 members.

The inner member 401 is retained in the intermediate member 402, and the intermediate member 402 is retained in the outer member 403 in the same way that the inner member 201 in FIG. 2 is retained in the outer member 202.

A first shaft or other structural element may be engaged in the central bore in the first annular member 401 and a second shaft or other structural element may be engaged with the outer member 403. For that purpose the outer member 403 may be fixed to or integral with a flange (not shown) or it may comprise other means, for example external splines, for coupling to a structural element.

One use of couplings of FIG. 4 is as a universal joint. The coupling allows angular misalignment of the shafts by virtue of the relative rotation of the intermediate member 402 and outer member 403 about the third axis A3 and second axis A3 respectively.

Both the inner member 401 and the intermediate member 402 comprise spherical segments about the central point C.

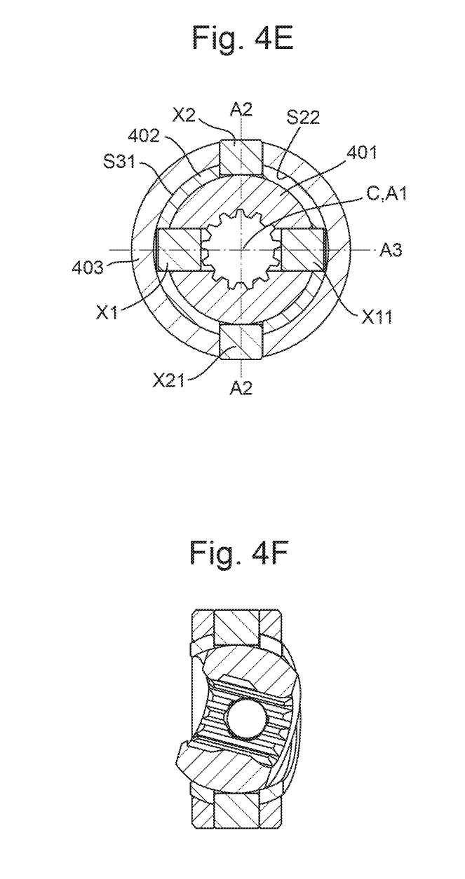

In FIGS. 5A and 5B coupling arrangements comprising two couplings of the kind illustrated in FIG. 4 are shown.

In FIG. 5A the comprising two couplings E2 of FIG. 4 connected together by a connecting structure 66. The structure rigidly connects the two couplings. The connecting structure 66 is a tube coupling the outer members 403. In another example, instead of the tube, the outer member 403 of one coupling is connected by a connecting structure 67 to the first member 401 of the other as shown for example in FIG. 5B.

The coupling arrangement of FIG. 5A is an approximation to a double Cardan joint, if the axle pairs of one of the individual couplings E2 are non-orthogonal to corresponding axle pairs of the other.

If instead of using the couplings E2 of FIG. 4, the couplings of FIG. 2 are used, the coupling arrangement is a crank handle if the axles of the two couplings are in the same orientation. In other examples the axle(s) of one coupling are orthogonal to the projection(s) of the other.

One of the couplings may be free to move axially in the tube 66.

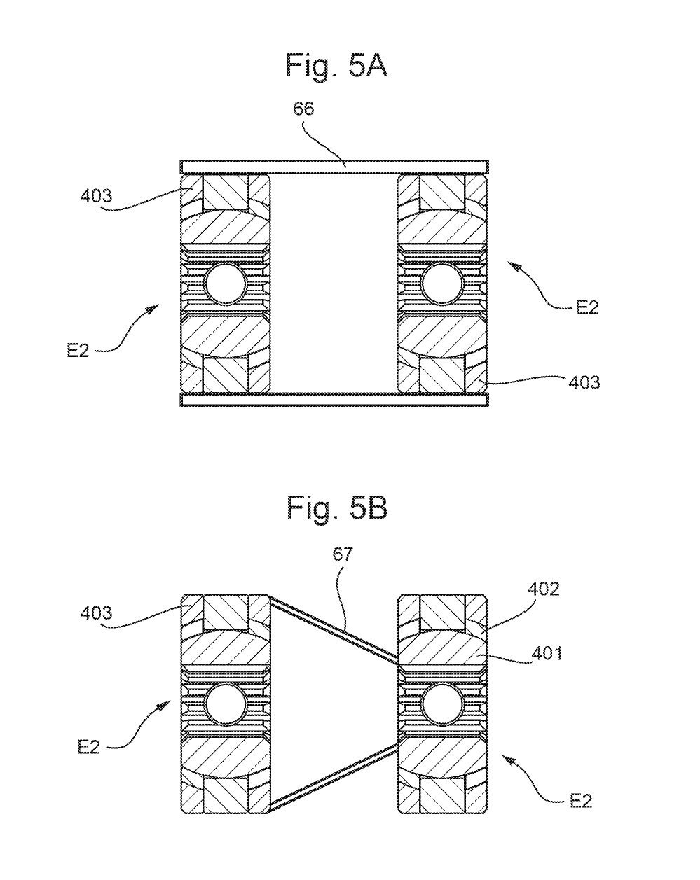

The coupling of FIG. 6 comprises an inner annular member 601, first, second third intermediate annular members 602, 603, 604 and outer annular member 605.

It has been found that the third intermediate 604 and outer member 605 must be offset relative to the inner and first intermediate members 601 and 602 along the axis A1 when the members are aligned (see FIG. 6D). The offset may be slight. This may be achieved by offsetting the outer spherical surface S32 of the second intermediate member 603 axially of the inner spherical surface S31 of the second intermediate member 603. Thus using the frame reference of FIG. 1, the inner and first intermediate members 601 and 602 are centred on central point C and the second and third intermediate members 603 and 604 are centred on point C2.

The first annular member 601 has an outer peripheral surface S1 which is convexly spherical centred on the central point C on the first axis A1. The first annular member 601 has a central cylindrical bore 40 which in this example has splines 42 for engaging a correspondingly splined shaft.

A first intermediate annular member 602 has an inner peripheral surface S21 which is concavely spherical complementary to the outer surface S1 of the inner member 601. Surfaces S1 and S21 are contiguous plain bearing surfaces.

A first pair of diametrically opposed axles X1, X11 extends along the third axis A3 radially of the first axis A1 to couple the inner member 601 and first intermediate member 602. The first pair of axles constrains the pair of members comprising inner and first intermediate members 601 and 602 to be rotatable one relative to the other about the third axis A3 of rotation through and perpendicular to the first axis A1.

The first intermediate member 602 has an outer periphery S22 which is convexly spherical. A second intermediate annular member 603 has an inner peripheral surface S31 which is concavely spherical complementary to the outer surface S22 of the first intermediate member 602. In this example the inner spherical surface S31 of the second intermediate member 603 and the outer spherical surface S22 of the first intermediate member 602 are contiguous, plain, bearing surfaces.

A second pair of diametrically opposed axles X2, X21 extend along the second axis A2 radially of the first axis A1 coupling the pair of members comprising the first and second intermediate members 602 and 603. The second axle pair constrains the first intermediate member 602 and second intermediate member 603 to be rotatable one relative to the other about the second axis A2 of rotation through the central point C, and perpendicular to the first axis and perpendicular to the third axis A3. The second pair of axles allows relative rotation of the pair of members 602 and 603 members independently of the pair of members 601 and 602.

The second intermediate member 603 has an outer periphery S32 which is convexly spherical. A third intermediate annular member 604 has an inner peripheral surface S41 which is concavely spherical complementary to the outer surface S32 of the second intermediate member 603. In this example the inner spherical surface S41 of the third intermediate member 604 and the outer spherical surface S32 of the second intermediate member 603 are contiguous, plain, bearing surfaces.

A third pair of diametrically opposed axles X3, X31 extend along the second axis A2 radially of the first axis A1 coupling the pair of members comprising the second and third intermediate members 603 and 604. The third axle pair constrains the members 603 and 604 to be rotatable one relative to the other about the axis A21 of rotation through the central point C2, parallel to axis A2. They thus constrain the pair of members 603 and 604 to be rotatable one relative to the other about axis A21. The third pair of axles allows relative rotation of the second and third intermediate members independently of the first and second intermediate members.

The third intermediate member 604 has an outer periphery S42 which is convexly spherical.

An outer annular member 605 has an inner peripheral surface S51 which is concavely spherical complementary to the outer surface S42 of the third intermediate member 604. In this example the inner spherical surface S51 of the outer member 605 and the outer spherical surface S42 of the third intermediate member 604 are contiguous, plain, bearing surfaces.

A fourth pair of diametrically opposed axles X4, X41 extends along axis of rotation A31 parallel to axis A3 but though centre point C2. The fourth axle pair constrains members 604 and 605 to be rotatable one relative to the other about A31 and perpendicular to axis A21. They thus constrain the members 604 and 605 to be rotatable one relative to the other about axis A31. The fourth pair of axles allows relative rotation of the pair of members 604 and 605 independently of the pair of members 603 and 604.

The members are retained in the coupling in the same way as described hereinabove with reference to FIG. 2.

The axles X1 to X41 are identical to the axles X1 and X11 of FIG. 2.

In FIGS. 6A to 6F the inner and first intermediate members 601 and 602 comprises spherical segments about the central point C, the second and third intermediate members 603 and 604 also comprises spherical segments but about point C2. However, the central aperture of second intermediate member 603 is a spherical segment about the central point C, the first intermediate member 602 is received into this aperture.

One illustrative use of the coupling of FIG. 6 is as a double Cardan joint.

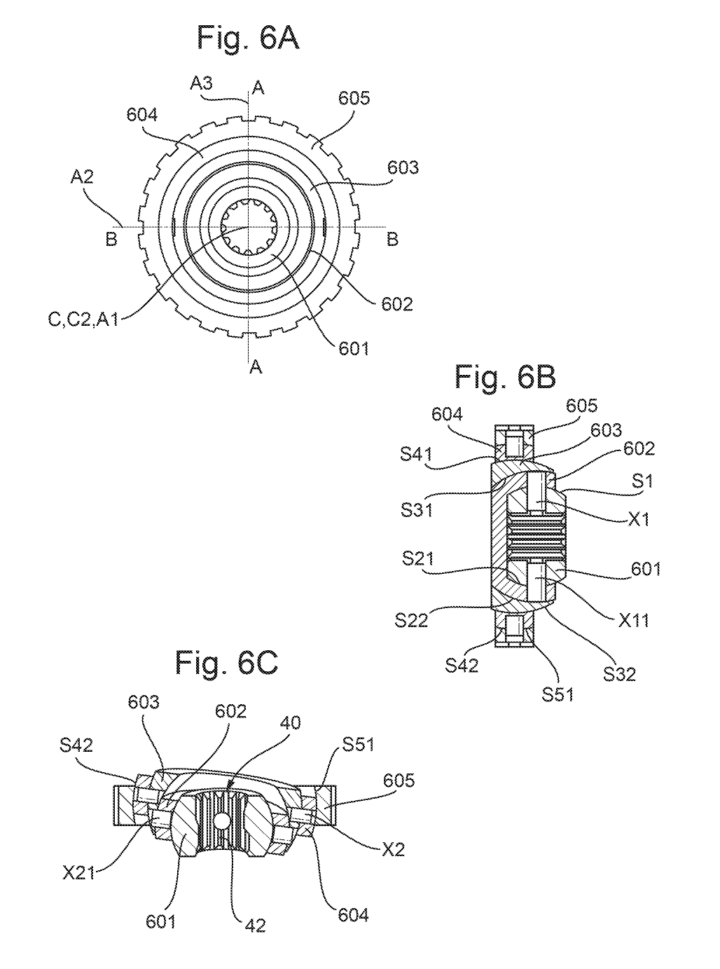

In the examples of FIGS. 2 to 6, the spherical surfaces are all contiguous plain bearing surfaces. Rolling element bearings may be provided between the adjacent spherical surfaces. In FIG. 7, ball bearings 100 held in one or more cages 101 may be provided at the surface of a member of a coupling. In the example of FIG. 7, the balls are held in two ball baskets, which are half spherical pieces, between the axles X, which may be axles X1 and X11 of the inner member 701 and outer member 702. Thus the spherical surfaces have rolling elements for carrying radial and axial loads. The radial load path is independent of the torque load being applied. This approach is more efficient than using balls in grooves to carry both the torsion and the radial load. As shown FIG. 7 is a two member coupling, however, the principles of FIG. 7 can be extended to a bearing having one or more intermediate members as shown in FIG. 4 or 6.

As an alternative or in addition rolling element bearing 102 may also be mounted on the axles to reduce friction.

The inner member 701 comprises a spherical segment about the central point C. In FIG. 7 the axles X1 and X11 have heads H inset into outer member 702 and screw threads engaging threads in the bores of outer member 702.

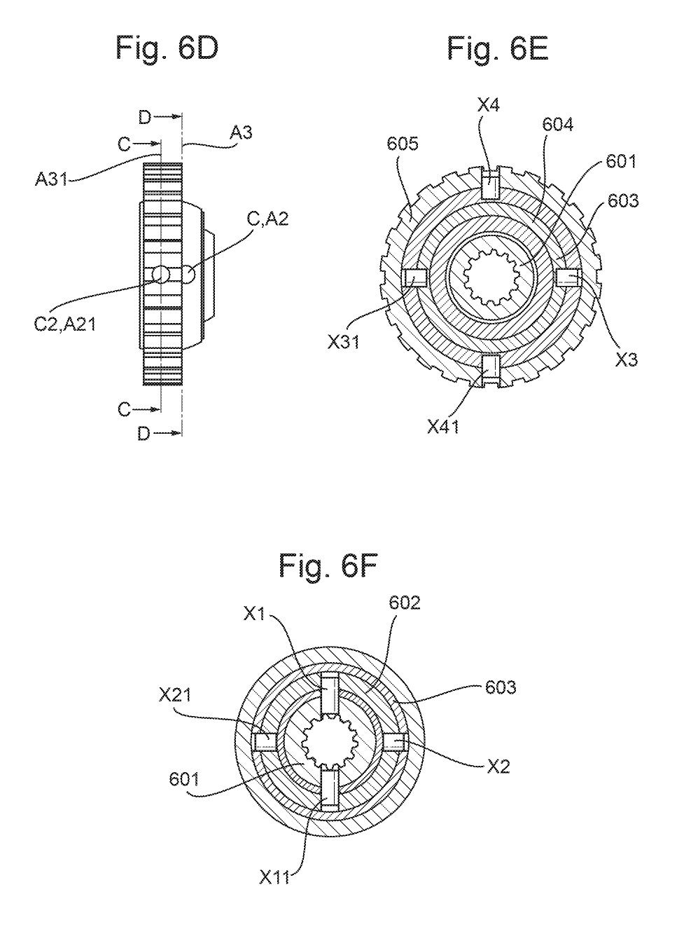

The spherical surfaces of adjacent members in the examples co-operate to bear radial and axial loads. To ensure that the coupling can bear a desired axial and radial load the spherical surfaces need to overlap sufficiently. Thus in embodiments of the invention, means may be provided to limit the relative rotation of adjacent members. Such limiting means also assists the retention of each inner ring in its associated outer ring. For example of such limiting means may be a stop within the coupling such as in FIG. 8. In FIG. 8 a fixed pin N projecting from an outer member 2 into a slot L in an inner member 1. It will be appreciated that any other suitable means of limiting relative may be used. In some examples the coupling is supported by a support structure which limits relative rotation. In others the structural elements coupled by the coupling limit the relative rotation.

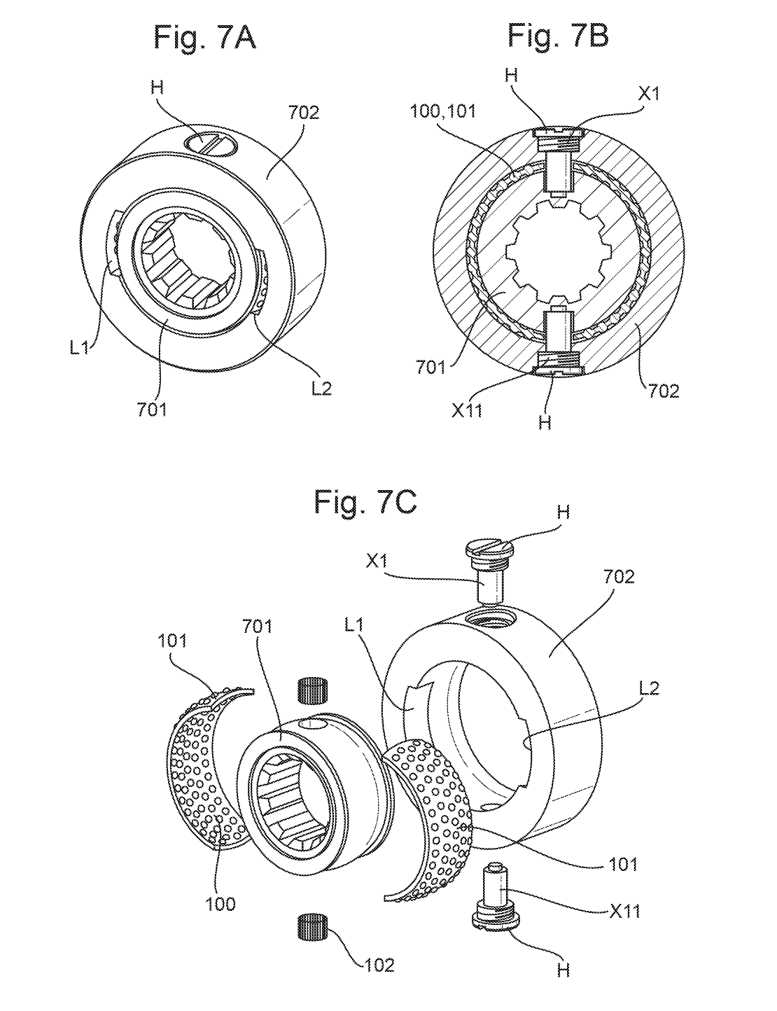

As shown in FIG. 9, to increase the operational range of relative rotation, the outer 2 or 3 of adjacent members 1 and 2 or 2 and 3 may be larger in the axial direction than the inner one 1 or 2. FIG. 9 shows three annular members 1, 2 and 3 as in FIG. 4. The principle of this FIG. 9 may be applied to any of the pairs of annular members of the examples of the invention.

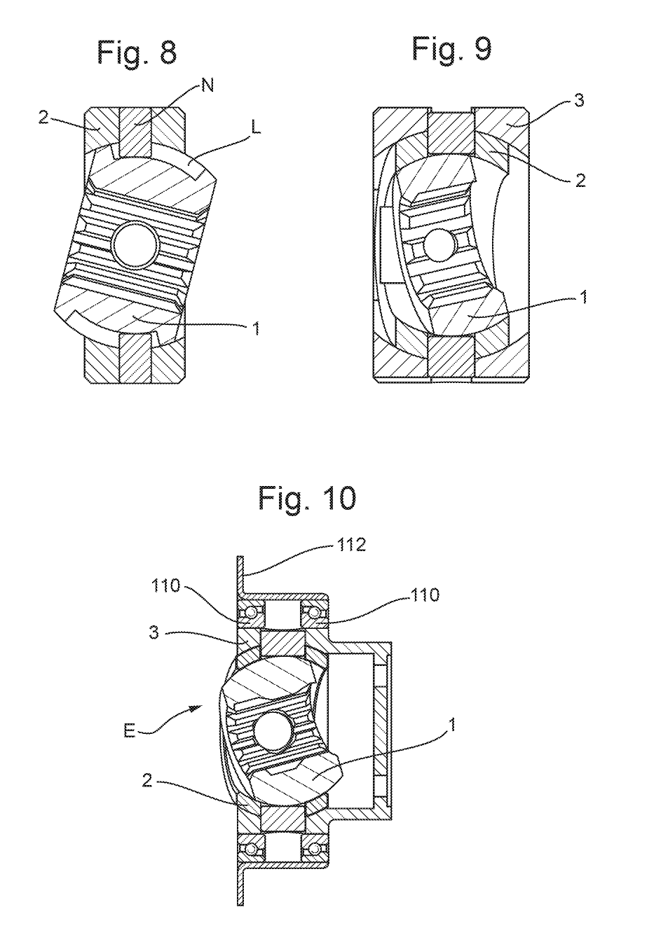

Referring to FIG. 10, any of the examples of FIGS. 2, 4 and 6 may be fixed within a bearing 110 which may be fixed to a fixed structure 112 for example a bulkhead, floor or wall. That allows the coupling to couple to any two structural elements, one each side of the fixed structure 112, that must be coupled with at least two rotational degrees of freedom. For example the fixed structure may be a bulkhead of a vehicle and the coupling couples section of a steering mechanism of the vehicle.

The bearing 110 allows the coupling E of FIG. 10 to rotate within the fixed structure 112.

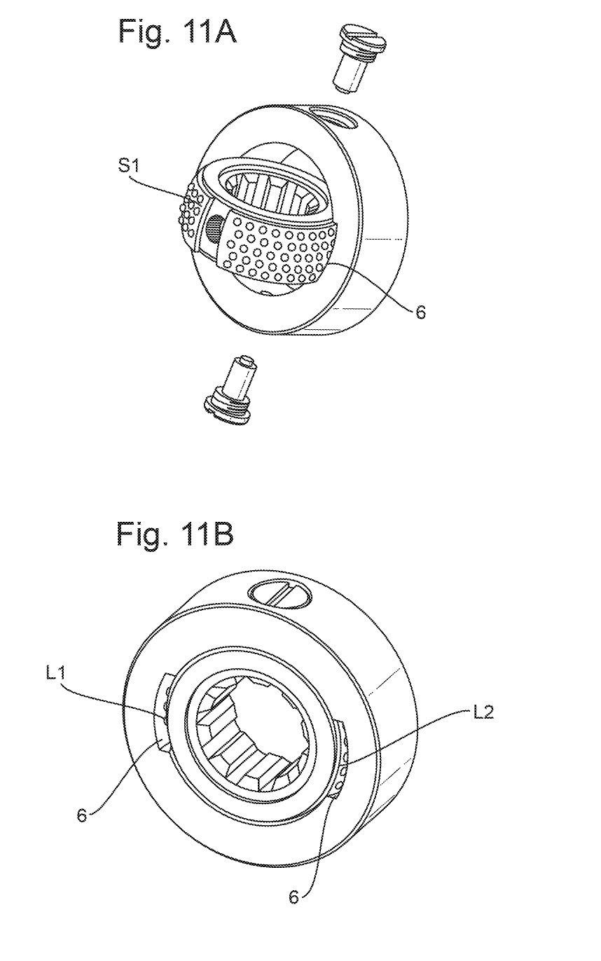

FIGS. 11A and 11B illustrate the assembly of a coupling. The coupling comprises a pair of annular members 1 and 2, an outer member 2 being outside an inner member 1. Member 2 has two diametrically opposite loading slots L1 and L2. The loading slots extend halfway across the width of the outer member 2 (the loading slots can also be seen in FIG. 7C). The slots are dimensioned so that the diametrically opposite floors 6 of the slots are spaced by the diameter of the outer surface S1 (including if provided the cages 101 as in FIG. 7) of inner member 1. The width of each slot is equal to or slightly greater than the width of the inner member. The inner member 1 is introduced sideways into the slots as shown in FIG. 11A and then rotated into the same plane as the outer member 2. The axle bore(s) of the pair of members 1 and 2 are brought into alignment at a suitable stage in the assembly process.

This option enables each member to be machined from a solid piece of material and minimises the risk of failure as a result of joining to halves together. The method described enables all the bearing surfaces described in this specification to be continuous, ie avoiding any joins (and thus weak areas) at the join of a member assembled in two halves bolted or welded together.

In FIG. 11 the pair of members 1 and 2 are representative of each member respectively of the pairs of members 201 and 202 in FIG. 2, 401 and 402, 402 and 403 in FIG. 4, 601 and 602, 602 and 603, 603 and 604, 604 and 605 in FIG. 6, 701 and 702 in FIG. 7.

In the examples above, for plain bearing surfaces, the mating convex and concave spherical surfaces should match accurately. That requires appropriately precise manufacture of the couplings.

A lining material may be injected between the spherical bearing surfaces. The convex spherical surfaces may be accurately machined. The concave spherical surfaces may be roughly machined to form a rough surface which is also a piece-wise linear approximation to a curved surface also known as cathedraling, and lining material injected between an accurately machined convex surface and the rough concave surface to form an accurately matched concave spherical surface. The convex spherical surface is coated with a release agent before the lining is injected into the coupling.

The lining material may be of plastic. The compositions of some of the plastics are not publically known as the suppliers are often commercially sensitive about their compositions. However Delrin® is one known product that could be used or PTFE based materials could be used.

In an alternative embodiment to those shown above, a structural element such as a shaft is fixed to or is integral with the inner member of a coupling. In an alternative embodiment, a structural element such as a shaft is fixed to or is integral with the outer member of a coupling. Structural elements may be fixed to or be integral with both the inner and outer members of a coupling.

The examples described above may have splines in the inner ring and or on the outer most peripheral surface of the coupling for connecting the coupling to structural elements to be coupled.

Alternatively any other suitable means of connecting the coupling to structural elements may be used. For example the outer periphery may have screw thread for connecting it to a correspondingly threaded structural element. Likewise the inner member may have a central bore which is screw threaded or employ keys to engage a shaft. The inner member may be integral with a shaft which is screw threaded for connection to another structural element. The outer member of the coupling may be connected to a structural element by any suitable means.

Couplings as described above may be made of any suitable material. The examples having plain bearing surfaces may be of metal, e.g. high performance steels, brass, bronze, aluminium, titanium etc. or of plastic, e.g. nylon, glass filled nylon, acetal, ABS, Delrin®.

It should be noted that the inner and outer annular members 401 and 403 of the coupling of FIG. 4 may be connected to respective shafts or other structural members so the intermediate member 402 is the only part which moves relative to the other two; this might lead a designer to select brass or bronze for the moving middle ring and steel for the inner and outer rings. The same philosophy could be applied to the other examples of the couplings.

Metal annular members rings may be lubricated by conventional lubricants for example grease. Alternatively, dry lubricant surfaces may be provided such as plastic liners as discussed above. The choice of materials and lubricants depends on the intended use of the coupling.

The inner member in all the examples comprises an annular spherical member with a central aperture for receiving a shaft. However, it may not have a central aperture but, for example, be bolted to a flange on a shaft.

In the examples shown in FIGS. 2 to 11, for maximum compactness, in each member of a pair of members comprising spherical segments has parallel sides in common planes when the segments are aligned. In particular in the arrangement of FIG. 2 each member of a pair of members comprises spherical segments having parallel sides in common planes when aligned. In the arrangement of FIG. 4 each member comprises spherical segments having parallel sides in common planes when aligned.

The open design of these couplings as shown in FIGS. 2 to 11 can lead to loss of lubricant in wet lubricated versions of the couplings and in any version, whether wet lubricated of not, to the ingress of dust and grit, which leads to wear, especially of the projections, slots, axles and bores in which they operate.

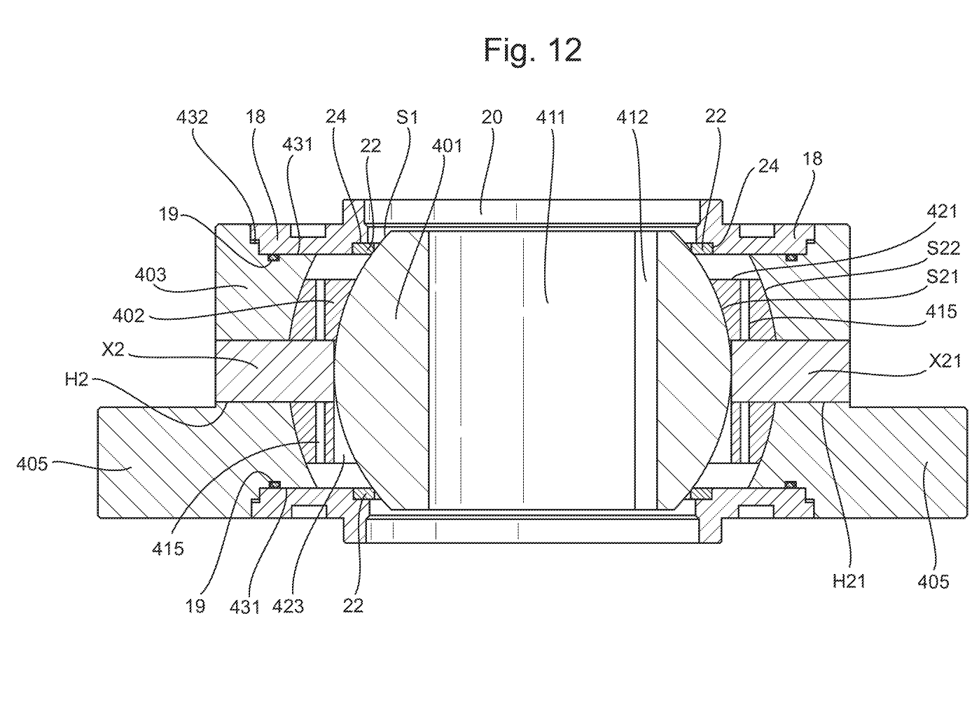

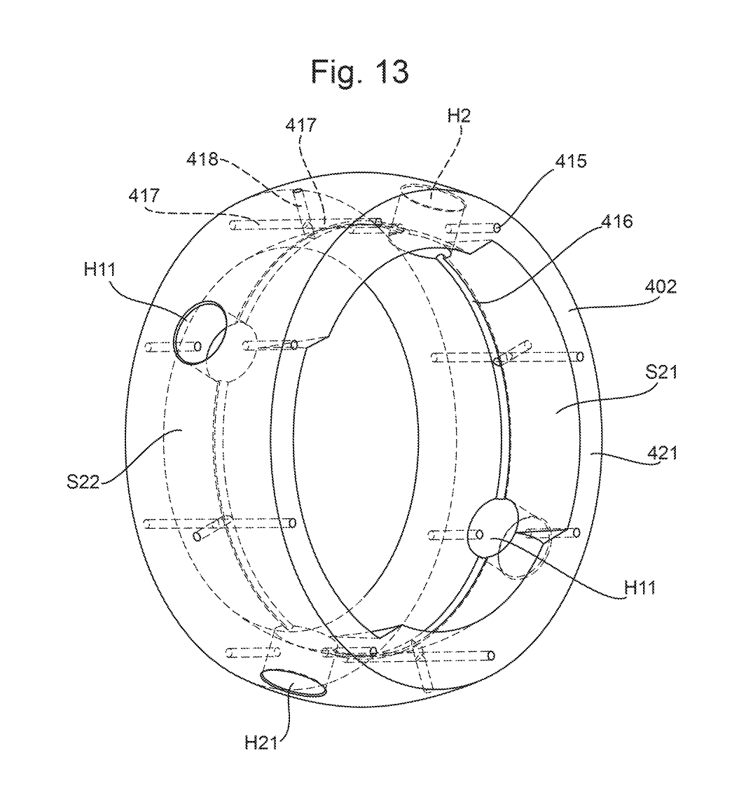

In a development of the invention one or a pair of seal support members having mounted thereon one or more annular seals, the one or more seals engages the spherical periphery of one of the annular members inside the seal support member. This is shown in FIGS. 12 to 14.

In one embodiment the one or more of seal support members comprise inwardly directed seal support rings, the seal support rings being mounted within a first of the annular members and the annular seals engaging the spherical periphery of a second of said annular member, said second annular member being inside the first annular member. Preferably two pairs of seals and seal rings are provided, one pair of seal rings mounted inside the outer member and with their associated seals engaging the outer spherical periphery of the second of the intermediate members, and the second pair of seal rings mounted inside the inner periphery of the second intermediate member with the associated seals engaging the outer periphery of the inner member.

The coupling shown in FIGS. 12 to 14 is similar to that shown in FIG. 4 but in which the outer member 403 is formed with a flange 405. The coupling comprises an inner annular member 401 and intermediate member 402 and an outer member 403. Rotation of the intermediate member 402 about the inner member 401 is constrained to rotate with respect to one another on an axis A2 perpendicular to central axis A1 by coupling these members with diametrically opposed axles X1 and X1. The outer annular member 403 is constrained to rotate in respect of the intermediate 402 by diametrically opposed axles X2 and X21, whose axes A3 is mutually perpendicular to the central axis A1 and axis of axles X1 and X11. The inner member 401 has a central bore 411 to receive a driving shaft (not shown) with a keyway 412 to receive a keyway on the driving shaft and to force the inner annular member 401 to rotate with the driving shaft,

The outer member 403 has a flange 405 to couple to an external member.

The outer member 403 has inner steps 432. The inner step 432 retains seal support discs 18 with a central aperture 20. Ring seals 22 are fitted to the rim 24 of the seal support discs 18 around apertures 20, closing any space between the rims 24 and the convex outer surface S1 of inner member 401.

The sides 421 joining the convex outer periphery S22 and the inner concave periphery of intermediate member S21 can be inclined inwards from the outer periphery of the member to the inner periphery of the member. The purpose of the inclined sides is to allow the intermediate member 402 greater range of movement before one of the sides 421 or the other contacts the seal support discs 18. If the sides were parallel the range of rotation of intermediate member 402 about inner member 401 would be restricted. A further O-ring seal 19 engages between seal 18 and the side faces 431 of outer member 403.

The axles X, X11, X2, X21 are mounted in axle holes H1, H11,H2, H21 respectively

Lubrication ducts 415 run between the side faces 421 of intermediate member 402 and each of the axle holes H1, H11, H2, H21. Further lubrication 417 pass through the intermediate member 402 from one side 421 to the other. There ducts 417 are disposed in the intermediate member about midway between each of the lubricating ducts 415. An annular channel 416 is formed at the apex of inner spherical surface S21 of the intermediate member 402, and further lubricating ducts 418 pass radially through the intermediate member 402, intersecting perpendicularly ducts 417, to the outer spherical surface S22 of intermediate member 402. A further annular channel 426 is formed at the apex of inner spherical surface S31 of the outer member 403.

In operation, as the members rotate with respect to one another, the gaps between the sides 421 of the intermediate member 402 and the seal support disc 18 will increase and decrease as the annular member 402 is rotated. This has the effect of pumping lubricant around the device. Additional lubrication can be supplied, if needed through axle holes H2 and H21.

Pairs of loading slots L1 and L3 enable assembly of the device as described with reference to FIG. 2.

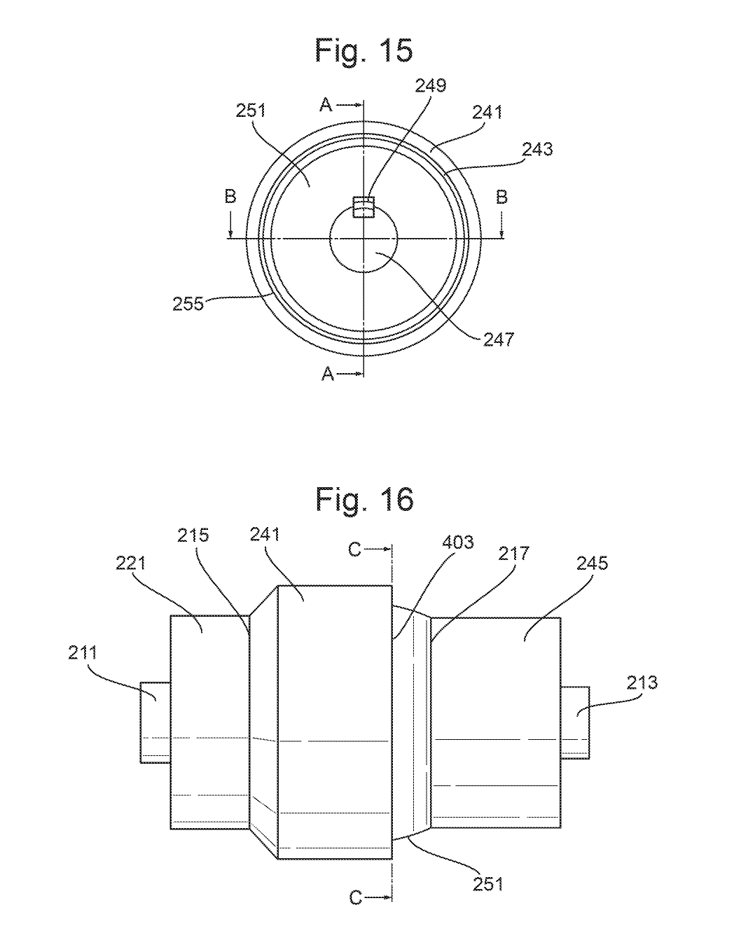

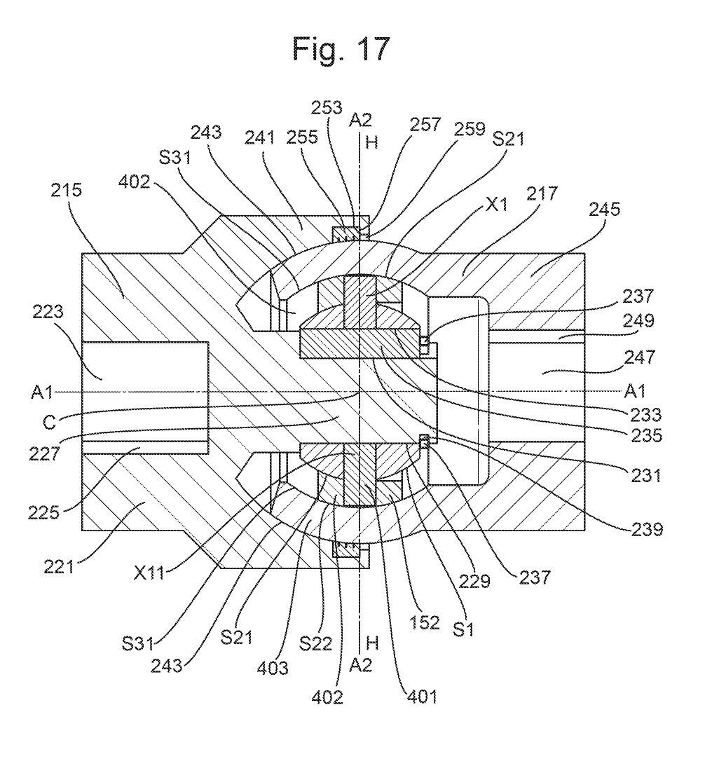

An alternative embodiment of the invention to that of FIGS. 12 to 14 is shown in FIGS. 15 to 20 which illustrates the application of a seal to a coupling shrouded by a “boot” to improve impact or blast damage resistance.

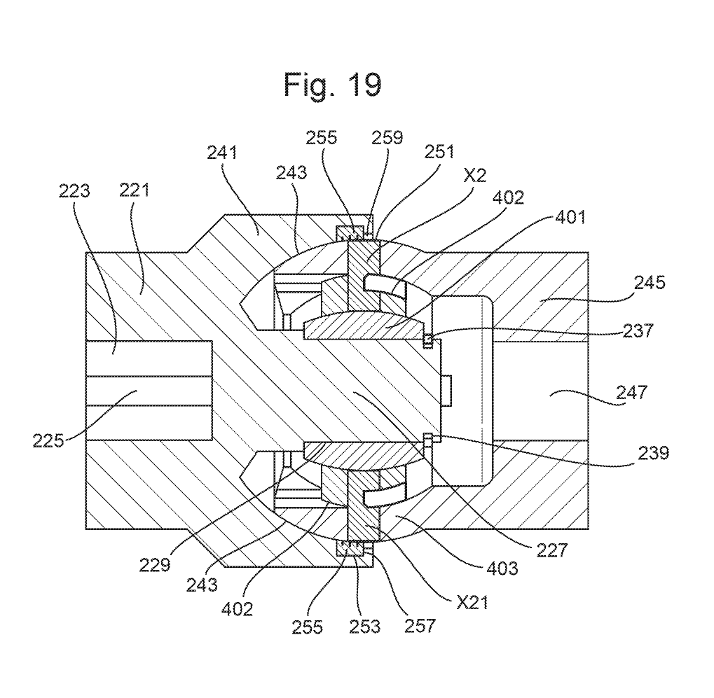

In FIGS. 15 to 20 a coupling between an input shaft 211 and an output shaft 213, comprises an input hub 215 and an output hub 217. For clarity the input and output shafts 211 and 213 are only shown in FIG. 18.

The input hub 215 has, at one end; a cylindrical profile 221, with a central bore 223 into which the input shaft 211 can be inserted. A longitudinal keyway 225 is provided in the central bore 223 to receive a key on the input shaft 211. The other end of the input hub 215 has a shaft 227 extending into the central bore 229 of inner annular member 601 of the coupling. The shaft 227 has a keyway 231, with the inner bore of the inner annular member 401 having a corresponding keyway 233. A key 235 is inserted in the keyways 231 and 233 to pass rotational movement of shaft 227 to inner annular member 401.

The coupling comprises a first, inner annular member 401, intermediate annular intermediate member 402 and an annular outermost member 403. Each of the members 401, 402, 403 comprises spherical segments about a common centre C (the same as the point C in FIG. 4). The inner annular member 401 has an outer peripheral surface S1 which is convexly spherical centred on the point C.

The intermediate annular member 402 has an inner peripheral surface S21 which is concavely spherical complementary to the outer surface S1 of the first inner member 401.

Diametrically opposite axles X1, X11 extends radially along an axis A2 perpendicular to the axis A1 of annular member 401 from axle apertures in the inner member 402 into apertures in inner member 401. The axles X1 and X11 constrain the first inner member 401 and intermediate member 402 to be rotatable one relative to the other about the axis A2 perpendicular to the central axis A1 of the inner annular member 401—the first axis.

The intermediate member 402 has an outer periphery S22 which is convexly spherical. The outermost annular member 403 has an inner peripheral surface S31 which is concavely spherical complementary to the outer surface S22 of the intermediate member 402.

Second pairs of axles X2 and X21, mounted in the outer member 403 and diametrically opposed to one another on an axis A3 which is perpendicular to both axes A1 and A2 extend into axles holes in intermediate member 402. Axles X2 and X21 constrain the intermediate member 402 and outer member 403 members to be rotatable one relative to the other about axis A3 and perpendicular to both the first axis A1 and second axis A2.

The inner member 401 is retained in the intermediate member 402, and the intermediate member 402 is retained in the outermost member 403.

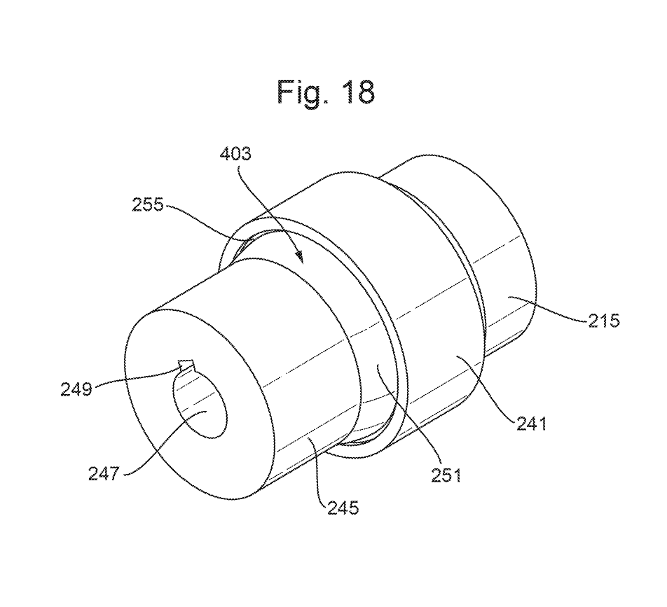

The input hub 215 also has a housing 241 which in this embodiment is the seal support member extending partially around the outside of the coupling. The inner surface of the housing has a hemispherical spherical inner surface 243. The hemispherical surface 243 extends around one half of the outer annular ring to a plane on the line HH (in FIG. 17); line HH is also the axis of rotation A2 as in FIG. 1. Beyond the plane intersecting the line HH, the housing is cut away to provide a surface 259 that is parallel to the axis A1 of the coupling. This cut away portion 259 enables the outer annular ring to be fitted into housing. The function of this housing 241 and its hemispherical inner surface 243 is described further below. Shaft 227 projects from the hemispherical surface 243 into bore 229 of the inner annular member 401.

The outer member 403 has a contiguous cylindrical extension 245, extending from the coupling in an opposite direction to the cylindrical profile 221 of input hub 215. Together the outer member 403 and the extension 245 form the output hub 217. Cylindrical extension 245 has an inner bore 247 into which output shaft 213 may be received. The bore has a keyway 249 to receive a key on the output shaft 213, thus to pass torque and rotational motion of the outer annular member 403 to the output shaft 213.

The outer surface of outer annular member 403 is has an outer spherical surface 251 corresponding to the hemispherical inner surface 243 of housing 241. The hemispherical housing and the outer annular member 403 can, in the design illustrated, rotate about each other by up to 17.5°. By altering the relative dimensions of the components the degree of rotation can be increased of decrease, but any increase may come with a lessening of the overall strength of the coupling.

The periphery of the hemispherical inner surface 243 of the housing 241 has a groove 253 in which an annular seal 255 is housed, the seal 255 sealing between the housing 241 and the outer spherical surface of the outer annular member 403. The spherical inner surface 243 of the housing and the outer spherical surface 251 of the outer member 403 are also centred on point C (i.e. they are concentric with the spherical surface S1, S21, S22 and S31 of the annular members 401 (S1), 402 (S21, S22), 403 (S31), and a seal plane H-H (marked in FIG. 17) is formed at the edge 257 of seal 255 and passing through the centre point C. It is possible to construct the groove 253 slightly further to the left as seen in FIG. 18, so that the plane HH passes through a point on the axis A1 further to the left (when viewed as in FIG. 17).

A snap ring 237 engaging in a circumferential groove 239 in shaft 227 bears on the one side 230 of the inner annular member 401 holding the input hub (and thus housing 241) in place with respect to the rest of the assembly, and the outer spherical surface of the 251 of the outer member in particular. The snap ring 237 also holds key 235 in place in keyways 231 and 233.

To assemble the coupling inner annular member 401 is located within intermediate ember 402 and axles X1 and X11 fitted in place. The assembly of the inner and intermediate members is then placed in the outer member 403 and axles X2 and X21 fitted. Key 235 is located in keyway 231 and snap ring 237 is over-compressed within grove 239. The shaft 227 is then forced through the bore 229 of the inner annular member 601. When the snap ring 237 reaches the opposite end of bore 229 it expands locating against side 230 of the inner annual member, locking the whole assembly in place. As shown in the figures the snap ring has a rectangular cross section, and once the snap ring is located in place, the assembly is not easily dismantled. A circular cross section snap ring would be used should it be required to dismantle the assembly more easily. In an embodiment in which the shaft 227 and the bore 229 of inner annular member 401 have co-operating splines (for example the splines of FIG. 4), the groove 239 may be formed in the splines, and the snap ring expanded into place in the groove in the splines in bore 229

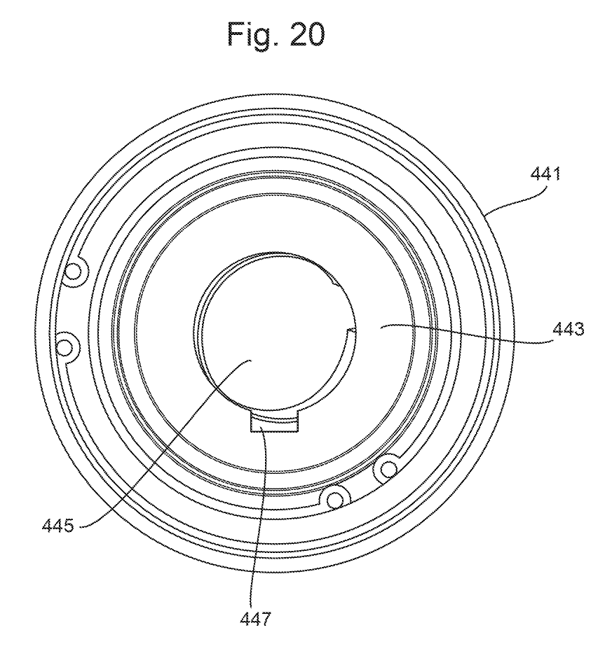

By looking at FIGS. 17 and 19 it can be seen that the coupling is completely sealed and dust and grit excluded by a combination of the shape of the input hub 215 and the seal 255 engaging the outer surface 251 of the outer annular member 403 thus in a wet lubricated coupling oil is completely sealed within the coupling.

As described previously with respect to FIGS. 12 to 14, in the embodiment of FIGS. 15 to 19, the sides 421 joining the convex outer periphery S22 and the inner concave periphery S21 of intermediate member 402 are inclined inwards from the inner periphery of the member to the outer periphery of the member.

In a wet lubricated joint, the lubrication arrangements of FIGS. 12 to 14 could be adopted.

As shown, the coupling of FIGS. 15 to 19 can cope with shaft misalignments of up to 17.5° between an input shaft 211 and an output shaft 213 connected to an input hub 215, However by reducing the diameter of body 245 of the output hub 217, the degree of misalignment can be increased, although with the risk that the overall strength of the coupling will weaken.

The sealing system, shown in FIGS. 15 to 19 is strong and robust, although an additional convoluted rubber sheath could be fitted around the outside of the coupling as an additional safeguard against ingress of contaminants.

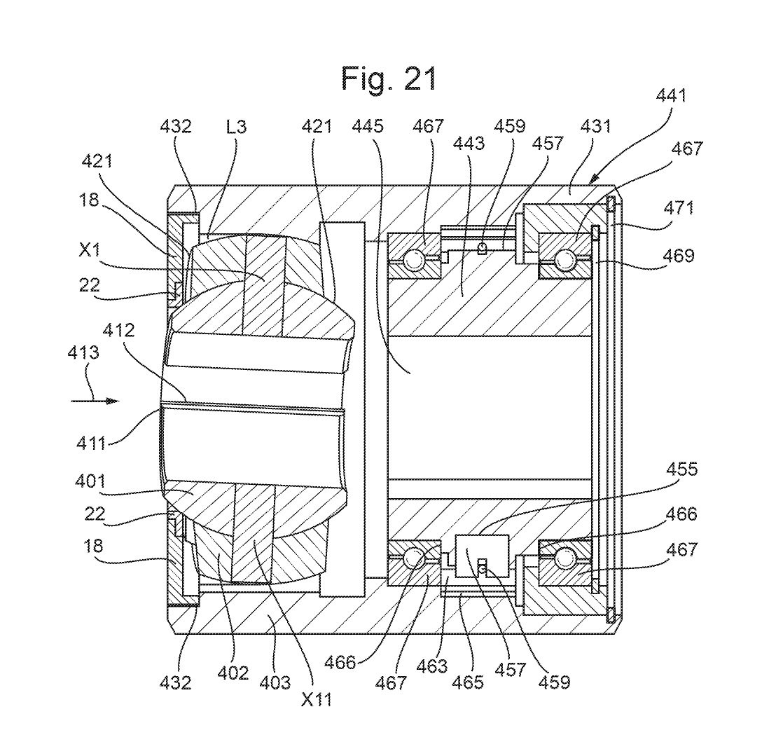

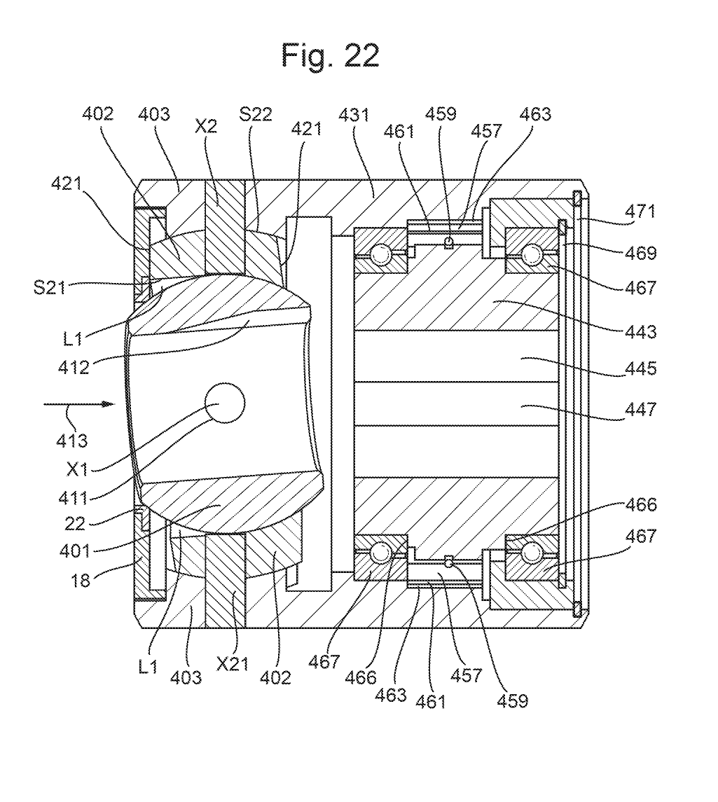

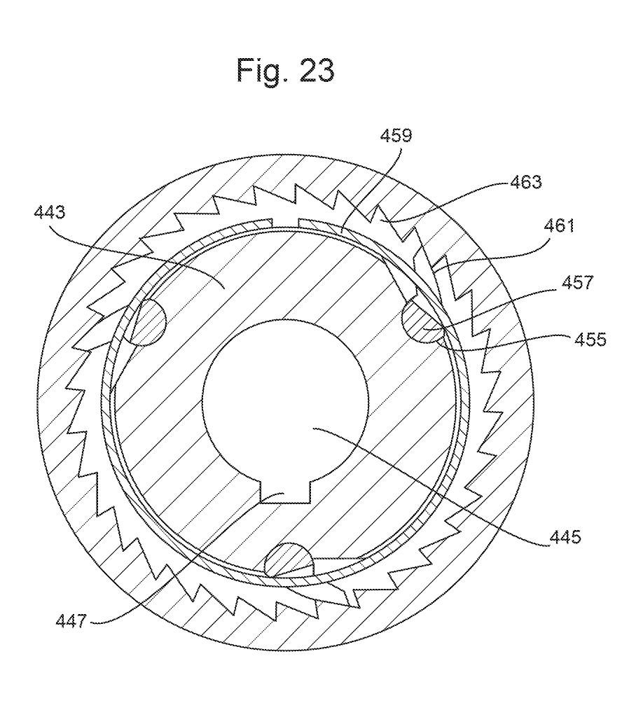

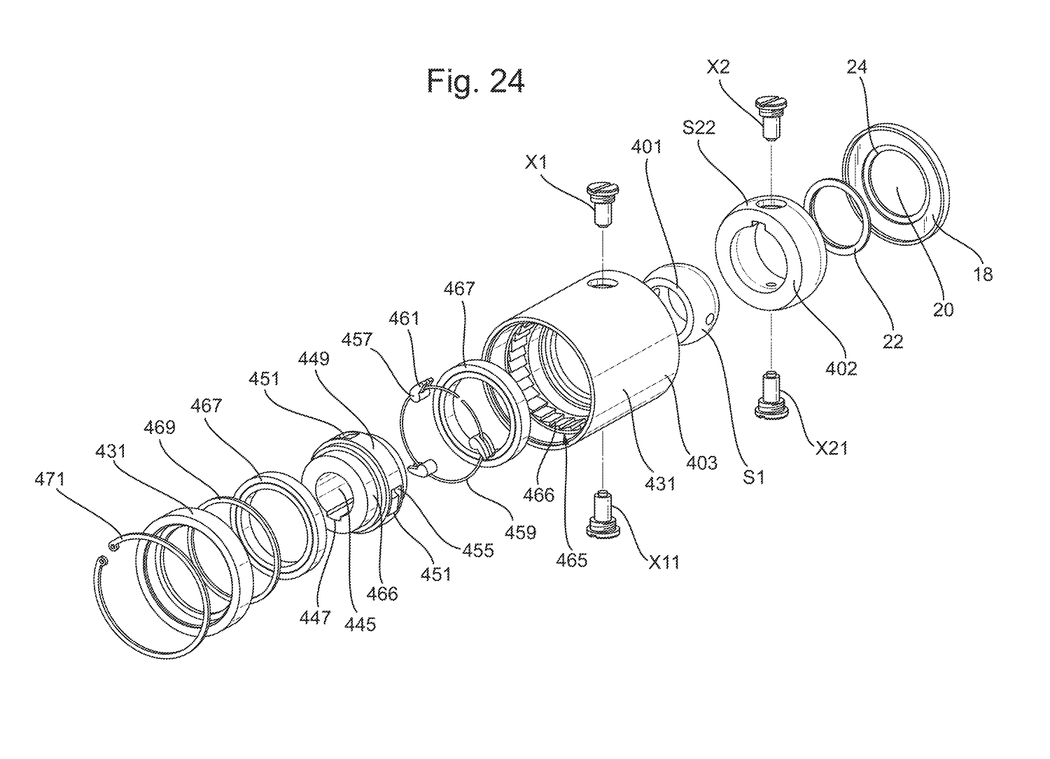

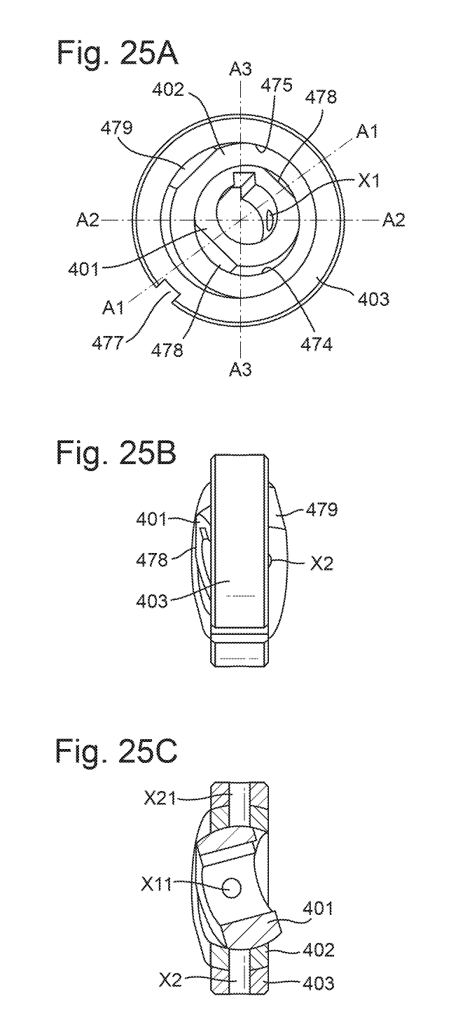

Application of the invention to a Spragg or freewheel clutch is illustrated in FIGS. 20 to 24.

The coupling shown in FIGS. 20 to 24 is similar to that shown in FIG. 4 but the outer member is formed with a Spragg clutch. The coupling comprises an inner annular member 401, having a central bore 411 receive a driving shaft (not shown), with a keyway 412 to receive a keyway on the driving shaft and to force the inner annular member 401 to rotate with the driving shaft, and intermediate member 402 and an outer member 403. Rotation of the intermediate member 402 about the inner member 401 is constrained to rotate with respect to one another on an axis A2 perpendicular to central axis A1 the by coupling these members with diametrically opposed axles X1 and X1. The outer annular member 403 is constrained to rotate in respect of the intermediate 402 by diametrically opposed axles X2 and X21, whose axes A3 is mutually perpendicular to the central axis A1 and axis of axles X1 and X11.

The outer member 403 has an annular extension 431 laterally but opposite the direction 413 from which a shaft may be inserted into the central bore 411 of annular member 401. This annular extension 431 forms the body of a Spragg clutch or free-wheel mechanism 441. The mechanism 441 itself is conventional and comprises a annular member 443 with a central bore 445 and a key way 447 formed in the periphery of the bore to receive the key of a shaft (not shown) to be driven by the mechanism. The outer periphery 449 of the annular member 443 has three slots 451 with rounded inside surfaces 455 to receive the rounded ends of spraggs 457 mounted to rotate about a spring wire hoop 459 around the outer periphery 449 of annular member. The slots 451 are distributed evenly around the outer periphery 449. The spraggs have tails 461 which are pushed by the spring wire 459 into the teeth 463 of an internal ratchet 465. The teeth 463 are in the form of saw teeth, permitting the spraggs 457 to pass in one direction only.

Each end of the outer periphery of the annular member 443 has a stepped portion 466; annular bearings 467 are mounted either side of the stepped portions 466 of the annular member 443.

The mechanism 441 is held in place within the annular extension 431 with circlips 469 and 471.

The coupling itself incorporates a seal 22 held in place against the spherical outer surface S2 of the inner member 401 by a sealing ring 18 to retain oil lubricant within the coupling part and to exclude dust and grit. These arrangements as well as the lubrication ducts are as illustrated in detail in FIGS. 12 to 14.

Thus, the invention enables a Spragg or free-wheel clutch to operate between an input rotor and an output rotor, having considerable angular misalignment, in practice by including a coupling according to the invention with the Spragg clutch; misalignment of up to 15 degrees can be tolerated.

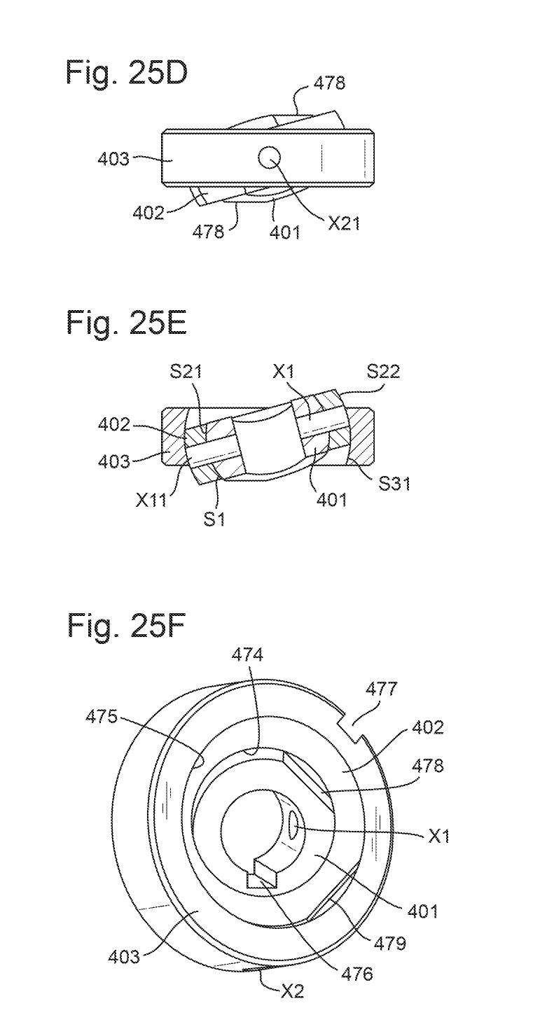

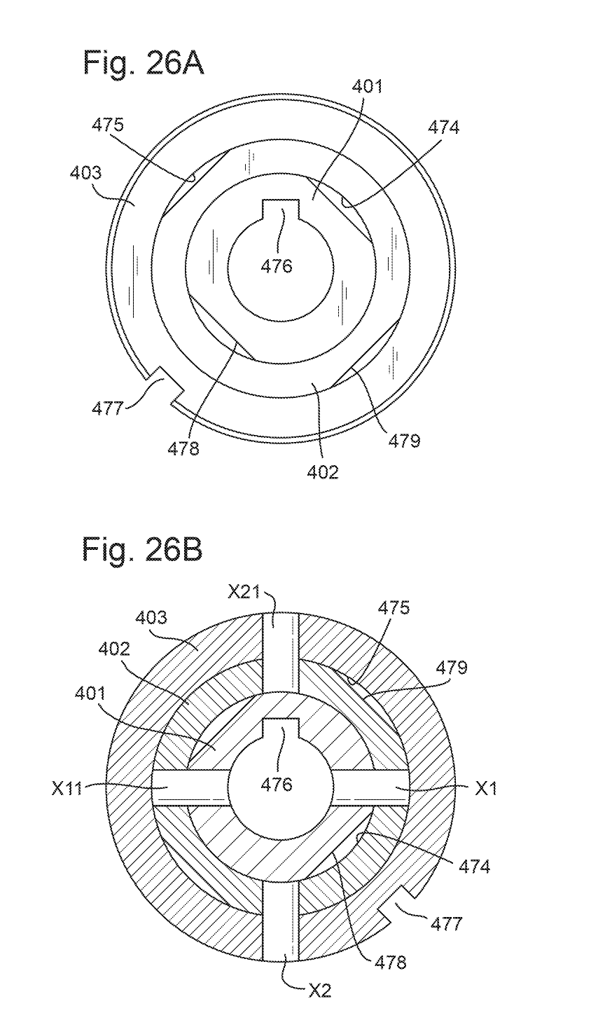

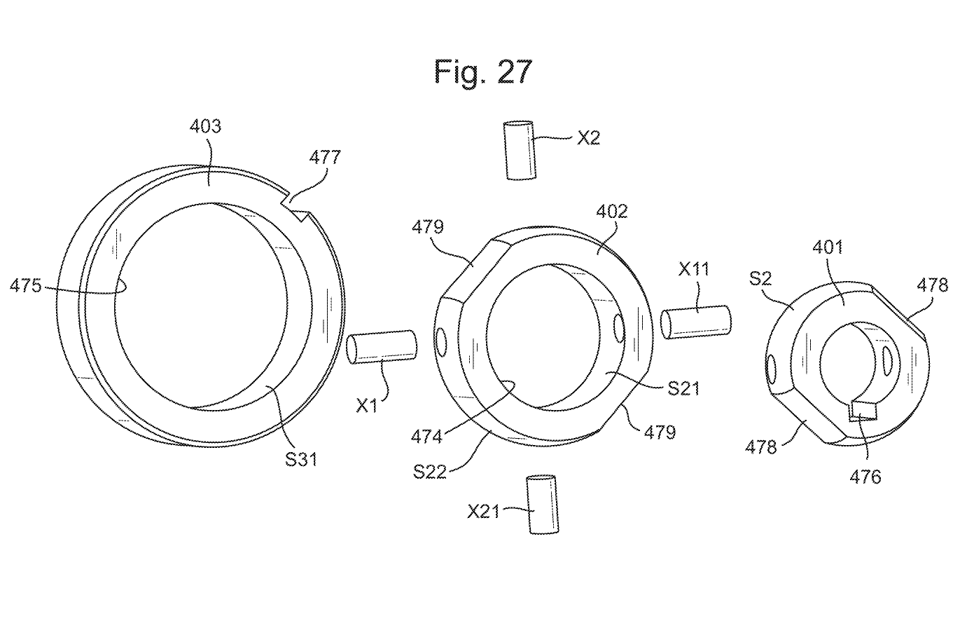

In FIGS. 25 to 27 coupling comprises an inner annular member 401, an intermediate member 402 and an outer member 403. The inner member 401 is centred on a first axis A1 and has an outer peripheral surface S1 which is convexly spherical centred on the point C on the axis A1. The inner annular member 401 has a central keyway 476 for engaging a key on a shaft.

The intermediate annular member 402 has an inner peripheral surface S21 which is concavely spherical complementary to the outer surface S1 of the first inner member 401. In this example the inner spherical surface S21 of the intermediate member 402 forms a female race and the outer spherical surface S1 of the first inner member the male bearing surface.

A first pair of diametrically opposed axles X1 and X11 extend radially of, the first axis A1 on the third axis A2 to couple the inner member 401 to the intermediate member 402. The first and second axles constrain the inner and intermediate members to rotate one relative to the other about the third axis A2. The intermediate member 402 has an outer periphery S22 which is convexly spherical. The intermediate member 402 has an outer periphery S22 which is convexly spherical and forms a second male surface of the invention. The outermost annular member 403 has an inner peripheral surface S31 which is concavely spherical complementary to the outer surface S22 of the intermediate member 402. The inner spherical surface S31 of the outermost member forms a second female race of the invention.

A second pair of diametrically opposed axles X2 and X21 extend radially of, the first axis A1 along the second axis A3 perpendicular to the third axis A2 to couple the intermediate member 402 to the outer member 403. The axles X2 and X21 constrain the intermediate 402 and outer 403 members to be rotatable one relative to the other about the second axis A3 of rotation (see FIG. 25) through the centre point C, and perpendicular to the first axis A1 and perpendicular to the third axis A2. The second pair of axles allows relative rotation of the pair of members comprising intermediate and outer members 402 and 403 independently of the pair of members comprising inner and intermediate members 401 and 402.

The male bearing surface S1 of inner member 401 has a cylindrical waist 478, which forms a pair of loading slots, is orthogonal to the first axis A1. However, to maximise the strength of inner member 401, the waist is positioned between axles X1, and X11, with its axis at 45° to the axes A2 and A3. The diameter of the cylindrical waist is just less than the aperture 474 of intermediate member 402.

To assemble the inner member 401 within the intermediate member 402, inner member 401 is lined up within intermediate member 402 to be at right angles to intermediate member 402. Inner member 401 is now rotated to bring surface S1, the male spherical bearing surface, into contact with the inner periphery S21 of the intermediate member 402. Axles X1 and X11 are then inserted into their axle holes.

Similarly, the male bearing surface S21 of intermediate member 402 has a cylindrical waist 479, which forms a second pair of loading slots, whose axis is and orthogonal to the first axis A1. However, to maximise the strength of inner member 401, the waist is positioned between axles X1, and X11, with its axis at 45° to the axes A2 and A3. The diameter of the cylindrical waist is just less than the aperture 475 of intermediate member 403.

To assemble the intermediate member 402 within the outer member 403, intermediate member 402 is lined up within outer member 403 to be at right angles to intermediate member 403. Intermediate member 402 is now rotated to bring surface S22, the male spherical bearing surface, into contact with the inner periphery S31 of the outer member. Axles X2 and X21 are then inserted into their axle holes and held in place with an interference fit with the axle holes in outer member 403.

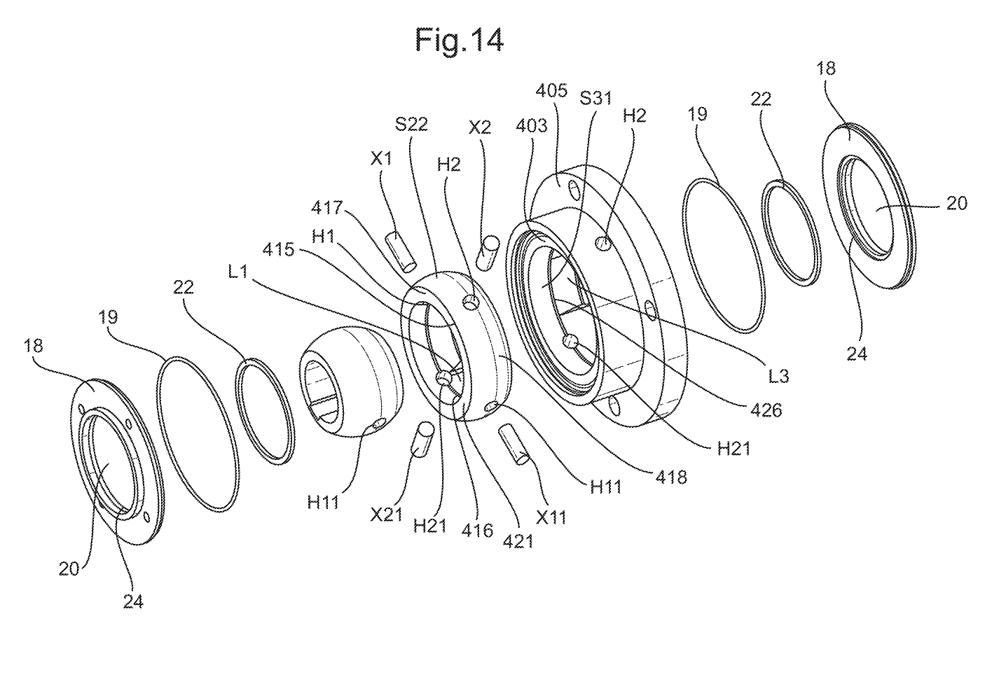

The arrangements of FIGS. 25 to 27 may be used in conjunction with the embodiments by replacing the intermediate member as shown in those figures with one of the kind shown in FIGS. 12 and 14, which has a waist 679 in the outer surface S22, but loading slots in the inner surface S21. In the construction shown in FIGS. 25 to 27, it would not be possible to provide waists in the outer surface S1 of the inner member as that prevent the seal 22 from sealing against the outer surface S1 of the inner member 601.

In addition to aiding loading the intermediate member 402 in the outer member 403, the space thus formed between the waisted portion 479 and the inner periphery S31 of the outer member 403 acts as a reservoir for lubricant or grease, greatly enhancing the lubrication of the coupling and

[symbol]

1. A coupling comprising an inner member and an outer annular member comprising one or more pairs of members which may or may not include one or both the inner and outer members, each pair being a first member and a second annular member with a common axis and having a common first centre on the common axis; a first member having an outer convex spherical periphery; the second annular member having an inner spherical concave periphery in which the outer convex periphery of the first annular member is received; the outer convex periphery and the inner concave peripheries being concentric about the first centre and complementary to one another and co-acting with one another to transmit axial loads acting along the common axis between them; one or a diametrically opposed pair of axles disposed radially of the common first centre for transmitting torsional load from one of the members to the other; the first and second members being constrained by the axle(s) to be rotatable one relative to the other about the axle(s); the convex and concave spherical surfaces being contiguous and bear radial loads of the coupling and wherein the second annular member of a pair of members retains the first member of a pair of members.

2. A coupling according to claim 1 in which the members, other than the outer member, comprise spherical segments including a common centre.

3. A coupling according to claim 1, further comprising a rolling element bearing between the convex and concave spherical surfaces and/or around the axle(s).

4. A coupling according to claim 1 in which the second annular member of a pair of members has a pair of diametrically opposed loading slots by which the first member of the pair of members may be inserted to be retained within the coupling, said slots being orthogonal to the axis of the axles joining the pair of members.

5. A coupling according to claim 1 in which the inner annular member of a pair of members has a waisted portion, forming a pair of opposed loading slots by which the first member of the pair of members may be inserted to be retained within the coupling. said slots being orthogonal to the axis of the axles joining the pair of members.

6. A coupling according to claim 5 in which the waisted potion is a reservoir for lubricant in a wet lubricated coupling.

7. A coupling according to claim 1, comprising an innermost member, an intermediate member and an outer-most member, the innermost member and the intermediate member comprising a first pair of members and the intermediate member and outermost member comprising a second pair of members and in which the axle(s) coupling the second pair of members is perpendicular to the axle(s) coupling the first pair of members, the second pair of members being rotatable one relative to one another independently of the first pair of members.

8. A coupling according to claim 1 having first, second and third intermediate members, the inner member and the first intermediate members forming one pair of members, the first and the second intermediate members being a second pair of members, the second and the third intermediate members being a third pair of members, and the third intermediate member and the outer most member being a fourth pair of members.

9. A coupling according to claim 8 wherein in the case of the third pair of members a plane containing their axles is perpendicular a plane containing the axles of the first pair of members and coincident with a plane containing the axles of the second pair of members.

10. A coupling according to claim 8 wherein the convex outer surface of the second intermediate member has an outer periphery which is convexly spherical about a common second centre which is offset from the common first centre in the direction of the common axis when the members are aligned.

11. A coupling according to claim 10 wherein the third intermediate member has its outer convex periphery centred on the second common centre and its inner concave periphery centred on the first common centre.

12. A coupling according to claim 8 wherein the axles connecting the fourth pair of members are parallel to the axles connecting the third pair of members and in which the fourth pair of members are rotatable relative to one another about the second common centre in a direction independently of the first, second and third pairs of members.

13. A coupling according to claim 1, wherein one of the innermost member and the outermost member is fixed against rotation about the torsional axis.

14. A coupling according to claim 1 wherein the outer member comprises a Spragg or ratchet clutch or freewheel element.

15. A coupling according to claim 1 wherein the coupling has one or a pair of seal support members with one or more annular seals mounted thereon, the one or more seals engaging the spherical periphery of one of the said annular members inside the seal support member.

16. A coupling according to claim 15 in which one or a pair of the seal support members comprise seal support rings, the seal support rings mounted within one of said annular members and the annular seals engaging the spherical outer periphery of a second of the annular members which is inside the annular member within which the seal support rings(s) are mounted.

17. A coupling according to claim 16 having lubricant over pressure is relief means.

18. A coupling according to claim 8 having one or a pair of seals engaging the outer spherical periphery of the second of the intermediate members, and a second or second pair of seal rings mounted inside the inner periphery of the second intermediate member with the associated seals engaging the outer periphery of the inner member.

19. A coupling according claim 16 in wherein the sides of an intermediate member incline outwards from the outer periphery of the member to the inner periphery of the member, the arrangement being such that on rotation of the intermediate member one side of the intermediate member is parallel to an adjacent seal support ring.

20. A coupling according to claim 16 wherein the outer annular member has a spherical outer periphery and the seal support member comprises a housing having an inner hemispherical surface extending partially around the spherical outer periphery of the said outer annular member, with a seal mounted on the inner hemispherical surface of the housing and engaging the spherical outer periphery of the outer annular member.

21. A coupling according to claim 16 wherein the coupling is within a housing having an inner hemispherical surface, the housing having a common centre with the common first centre.

22. A coupling according to claim 21 wherein a plane passing through the edge of the seal passes through the common first centre.

23. A coupling according to claim 22 wherein the housing extends beyond the seal parallel to the axis of the inner annular member and is formed contiguously with an input/output hub of the coupling, said hub being connected to the input or output of the coupling and projecting from the hub is a shaft engaging the inner annular member of the coupling.

24. A coupling according to claim 23 having one or a plurality of ducts through any intermediate member to permit flow of lubricant between spherical surfaces of the coupling.
